(19) United States
(12) Patent Application Publication
(10) Pub. No.: US 2005/0240781 A1
(43) Pub. Date: Oct. 27, 2005

(54) Prioritizing intrusion detection logs

(76) Inventor: Paul A. Gassoway, Norwood, MA (US)

Correspondence Address: RICHARD F. JAWORSKI;Cooper & Dunham LLP, 1185 Avenue of the Americas, New York, NY, 10036, US

(21) Appl. No.: 10/832,692

(22) Filed: Apr. 22, 2004

(51) Int. Cl. H04L 9/32

(52) U.S. Cl. 713/188

(57) ABSTRACT

A method for displaying an alert log including one or more alerts, the method including prioritizing the one or more alerts according to an importance of each of the one or more alerts and displaying the one or more alerts according to the priority.

### BACKGROUND

1. Technical Field

The present disclosure relates to intrusion detection and, more specifically, to prioritizing intrusion detection logs.

2. Description of the Related Art

In today's highly computer dependant environment, computer security is a major concern. The security of computer networks is routinely threatened by malicious programs such as computer viruses, Trojan horses, worms and the like. Once computer networks have been infected with these malicious programs, the malicious programs may have the ability to damage expensive computer hardware, destroy valuable data, tie up limited computing resources or compromise the security of sensitive information.

Computer viruses are malicious computer programs that may be capable of infecting other computer programs by inserting copies of themselves within those other programs. When an infected program is executed, the computer virus may be executed as well and can then proceed to propagate.

A Trojan horse is a malicious computer program that has been disguised as a benign program to encourage its use. Once executed, a Trojan horse may be able to circumvent security measures and allow for unauthorized access of a computer system or network resources either by the Trojan horse itself or by an unauthorized user.

A worm is a malicious program that propagates through computer networks. Unlike viruses, worms may be able to propagate by themselves without having to be executed by users.

Worms can be a particularly catastrophic form of malicious programs. Worms can infect a computer network and quickly commandeer network resources to aid in the worm's further propagation. In many cases malicious code, for example worms, propagates so rapidly that network bandwidth can become nearly fully consumed threatening the proper function of critical applications.

After malicious programs have infected computers and computer networks a destructive payload can be delivered. Destructive payloads can have many harmful consequences. For example, valuable hardware and/or data can be destroyed, sensitive information can be compromised and network security measures can be circumvented.

To guard against the risk of malicious programs, businesses may often employ antivirus programs, intrusion detection systems and/or intrusion protection systems. Antivirus programs are generally computer programs that can be used to scan computer systems to detect malicious computer code embedded within infected computer files. Malicious code can then be removed from infected files, the infected files may be quarantined or the infected file may be deleted from the computer system. Intrusion detection systems and intrusion protection systems (IDSs) are generally systems that can be implemented on a computer network that monitor the computer network to detect anomalous traffic that can be indicative of a potential problem, for example a worm infection. IDSs may be either active or passive. Active IDSs may take affirmative measures to remedy a potential infection when found while passive IDSs may be used to alert a network administrator of the potential problem. The network administrator is a person with responsibilities for the maintenance of computer systems and/or networks.

IDSs often attempt to identify the presence of network infection by analyzing packets of data that are communicated over the network. Antivirus programs often attempt to identify the presence of infection by analyzing files and memory locations of a specific computer. Packets, files and memory locations are generally examined and compared with signatures of known malicious programs. When a signature matches a packet, file or memory location, a malicious program infection may have been detected.

IDSs and antivirus programs that rely on signatures for the detection of malicious programs will generally keep a database of signatures for known malicious programs. IDSs and antivirus programs should be regularly updated to incorporate new signatures corresponding newly discovered malicious programs into the signature database. If no signature has been received and installed for a particular malicious program, the IDS or antivirus program might not be able to identify the malicious program.

While signature detection is generally a highly accurate method for detecting malicious programs, signature detection may be prone to detecting multiple instances of malicious programs that are not necessarily a threat to the computer system or network.

IDSs and antivirus programs may also rely on heuristics recognition for detecting malicious programs. Heuristic virus scans and IDSs may be able to intelligently estimate whether computer code is a malicious program by examining the behavior and characteristics of the computer code. This technique relies on programmed logic called heuristics to make its determinations. Heuristic recognition of malicious programs may not require the use of signatures to detect a malicious program. Heuristic recognition therefore has the advantage of being effective even against new and unknown malicious programs. However, heuristic recognition can be prone to misjudgment such as generating false negatives and false positives. When a scanned malicious program is not recognized as such, the heuristic recognition has generated a false negative. When the heuristic recognition has incorrectly categorized a program as malicious, a false positive has been generated.

It is often desirable for network administrators to employ antivirus and IDS programs that are capable of detecting malicious programs in the computer systems and networks. These antivirus and IDS programs are often programmed to generate an alert when an instance of a malicious program is detected. These alerts may then be stored in a database of such alerts so the administrator can periodically review the database for signs of a potential malicious program attack. Because signature detection may lead to multiple instances of malicious programs that are not necessarily a threat to the computer system or network and heuristic recognition may lead to false positives, important alerts in the alert log can often be hard to notice when surrounded by a great number of alerts of less significance.

### SUMMARY

A method for detecting malicious programs, the method including scanning data to be scanned to detect a malicious program infection, generating an alert when a malicious program infection has been detected and adding the alert to an alert log along with information pertaining to an importance of the detected malicious program infection.

A method for displaying an alert log including one or more alerts, the method including prioritizing the one or more alerts according to an importance of each of the one or more alerts and displaying the one or more alerts according to the priority.

A system for detecting malicious programs, the system including a scanning unit for scanning data to be scanned to detect a malicious program infection, a generating unit for generating an alert when a malicious program infection has been detected and an adding unit for adding the alert to an alert log along with information pertaining to an importance of the detected malicious program infection.

A system for displaying an alert log including one or more alerts, the system including a prioritizing unit for prioritizing the one or more alerts according to an importance of each of the one or more alerts and a displaying unit for displaying the one or more alerts according to the priority.

A computer system including a processor and a program storage device readable by the computer system, embodying a program of instructions executable by the processor to perform method steps for detecting malicious programs, the method including scanning data to be scanned to detect a malicious program infection, generating an alert when a malicious program infection has been detected and adding the alert to an alert log along with information pertaining to an importance of the detected malicious program infection.

A computer system including a processor and a program storage device readable by the computer system, embodying a program of instructions executable by the processor to perform method steps for displaying an alert log including one or more alerts, the method including prioritizing the one or more alerts according to an importance of each of the one or more alerts and displaying the one or more alerts according to the priority.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an example of the scanning of data according to embodiments of the present disclosure;

FIG. 2 shows a procedure for displaying an alert log according to embodiments of the present disclosure;

FIG. 3A shows an example of the displaying of an alert log that has been over crowded;

FIG. 3B shows an example of the displaying of an alert log according to an embodiment of the present disclosure; and

FIG. 4 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Intrusion detection systems, intrusion protection systems (collectively IDSs) and antivirus programs all work to scan files, memory and/or packets of data communicated over a network for the presence of malicious programs.

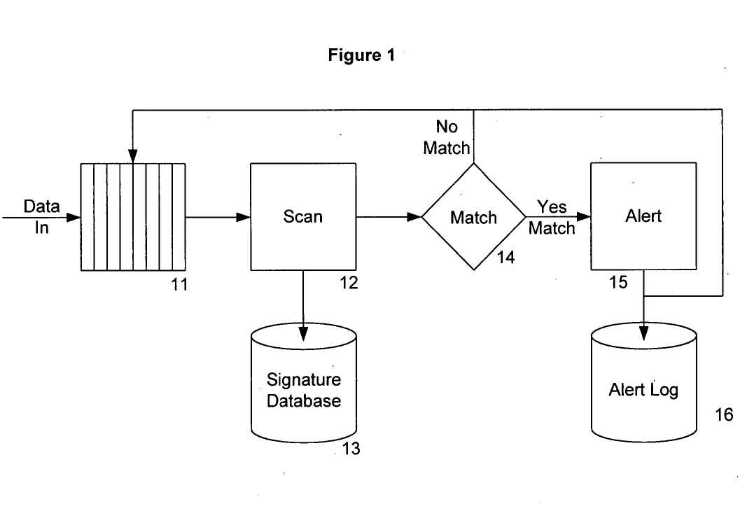

FIG. 1 shows an example of how data can be scanned according to embodiments of the present disclosure. Data to be scanned may be files located on a computer or server, data stored in memory on a computer or server or packets of data that are communicated across a computer network. Data may be periodically scanned as part of a periodic system scan or data can be scanned as files are executed or packets are communicated. Data to be scanned may first be sent to a data stack 11. The data stack stores data to be scanned so that data can continue to be collected even as the scanner 12 may be engaged in the scanning of other data. Data stack 11 stores units of data. A unit of data may be a part of a file, an entire file, data packets, etc. This data stack 11 can be particularly effective when the data to be scanned is comprised of packets that have been communicated over the network. This is because packets can often arrive much more quickly than data can be scanned by the scanner 12. When data to be scanned is comprised of packets, communication of packets should not be disrupted. Therefore, when the data stack has been filled to capacity with incoming packets, additional arriving packets may be disregarded and may not be scanned. Where data to be scanned is comprised of files or memory data collected as part of a system scan, the system scan can be delayed to collect additional data at the same rate that data is scanned by the scanner 12.

The scanner 12 compares collected data with signatures stored in the signature database 13. A signature is a representation of a malicious program that allows the scanner 12 to identify when data is potentially infected with the malicious program for which the signature has been created. A common technique for producing a signature is to compute the hash value of a malicious program. A hash value is a very large number that can be used to identify a file. The hash value can be determined by performing a mathematical algorithm on the data that makes up the file in question. There are many algorithms for calculating a file's hash value. Among these are the MD5 and SHA algorithms. While there are theoretically many different possible files that can all produce the same hash value, the chances of two different files having the same hash value are infinitesimal. The hash value of a file is not generally affected by changing the file's attributes such as renaming the file, changing the file's creation date and/or changing the file's size. For these reasons, the use of hash values can be well suited for the identification of potentially malicious programs. These and other techniques may be used to generate signatures according to the present disclosure.

According to embodiments of the present disclosure, the signature may also include a risk assessment value. The risk assessment value need not be used to identify a malicious program. Instead, the risk assessment value can be used to gauge the nature of the threat posed by data that matches a particular signature. The risk assessment value may be included with the signature by the signature developer, the person or program that has created the signature. The risk assessment value may be based on such factors as the potential for damage to computer systems and network caused by the malicious program upon which the signature has been developed and/or the likelihood that the potential damage will occur.

Risk assessment values may be created or modified by the network administrator, for example, where no risk assessment value has been included in the signature by the signature developer or the network administrator otherwise believes modification of the risk assessment values would be appropriate.

When using hash value signatures, the scanner 12 computes the hash value of the data being scanned and compares it to the hash values within the signature database 13. If using alternative forms of signatures other than hash values, the scanner 12 computes an appropriate signature for the data being scanned and compares it with the signatures in the signature database 13. It can then be determined 14 if the data being scanned corresponds to a signature in the signature database 13. If there is no corresponding signature found, the data stack 11 can supply the scanner 12 with the next unit of data to be scanned. When a match is made, an alert can be generated 15.

When using a heuristic scanner in addition to or as an alternative to the signature scanning, the signature database 13 can include or be replaced by a database of heuristics. Heuristics are the logical definitions used by the heuristic scanner to judge whether the data being scanned has been infected by a malicious program. Risk assessment heuristics may be incorporated into the heuristic scanner to gauge the risks posed by an observed infection. If the heuristic scanner determines that a unit of data is not infected with a malicious program, the data stack 11 supplies the scanner 12 with the next unit of data so the next unit of data can be scanned. When the heuristic scanner has determined that the data could be infected by a malicious program, an alert can be generated by the alert generator 15. The alert can then be stored in an alert log 16. The heuristic scanner can also pass to the alert generator 15 information pertaining to the confidence level in the match and/or a risk assessment value, for example, calculated by risk assessment heuristics, which can also be stored along with alerts in the alert log 16.

An alert can be a notification that notifies the network administrator of the detection of a potential malicious program. In addition to storing the alerts in the alert log 16, alerts can be automatically sent to the network administrator, for example by email or by pager. An alert can report the key attributes that gave rise to the match. For example, the alert can contain information pertaining to the time the match was made, the source of the data that was matched, the name of the signature that made the match, etc.

Alerts according to the present disclosure can also include the risk assessment value supplied by a signature scanner or a heuristic scanner and/or information pertaining to the confidence level in the match, for example, as obtained by a heuristic scanner.

The alert log 16 can be one or more databases of generated alerts. By storing alerts in the alert log 16, the administrator may periodically review generated alerts when convenient to do so.

The data stack 11 may supply the scanner 12 with the next unit of data to be scanned so that data may continue to be scanned. The scanning of data may end when there is no data left to scan, as would be the case, for example, upon the completion of a periodic system scan. However, where the data to be scanned is, for example, packets of data that have been communicated over the network, the scanning of data may be a continuing process.

The displaying of the alert log 16 can be problematic because the alert log 16 has the potential to include significantly more information than can easily be parsed by the network administrator. Signature scanning and heuristic scanning techniques can contribute to the overcrowding of the alert log 16. For example, not all malicious programs represent the same risks to the computer system or network that the malicious program has been detected on. For example instances of Nmap probes may be detected by signature scanners. Nmap is a publicly available utility for probing a network device, for example an application server, to determine what network services may have been made available by the application server. While Nmap has practical uses for maintaining a computer network, instances of Nmap probes can also be warning signs of potential malicious attack by a malicious program or a user with malicious intent. For this reason, signature scanners will often scan for the presence of an Nmap probe signature. However, the presence of an Nmap probe may most likely be harmless. Nmap probes are one example of a signature match that might not always be of importance to the network administrator. There may be many other signatures that detect the presence of malicious programs with a low potential for causing damage. However, such signatures may still be added to the signature database 13 because under certain conditions they may indicate a potential threat. The developer can add an indication to the database 13 for each of these signatures showing that they are low importance.

Code red is an example of a particularly harmful malicious program. Code red is a computer virus that can force a web server to attempt to contact other web servers, change the appearance of web pages on the web server and send out floods of packets tying up network resources. When the signature or signatures corresponding to code red are added to the signature database 13 by the developer, an indication is also provided that this is a high importance signature. When a match with one of the code red signatures is made, an alert identifying a match with a code red signature would indicate it is of high importance.

Heuristic scanners can contribute to alert log 16 overcrowding. Because heuristic scanners use logic to make judgments on whether data is infected with a malicious program, there may be an opportunity for false positives. A false positive is an alert that has been generated indicating a malicious program has been detected even when no such malicious program infection actually exists. It may be possible for the sensitivity of the heuristic scanner to be adjusted to produce fewer false positives, but to do so might increase the probability of a false negative. False negatives are malicious program infections that have been missed by the heuristic scanner. While false positives can contribute to alert log 16 overcrowding, false negatives can allow a malicious program to go undetected and potentially inflict significant damage on computer systems and networks. Therefore adjusting the sensitivity of the heuristic scanner might not always be the best solution for overcrowding of the alert log 16 caused by false positives.

Because heuristic scanners use logic to make judgments on whether data is infected with a malicious program, it is often possible for the heuristic scanner to pass along information pertaining to the heuristic scanner's confidence in the match. According to embodiments of the present disclosure confidence information can then be incorporated into the alert for the particular match.

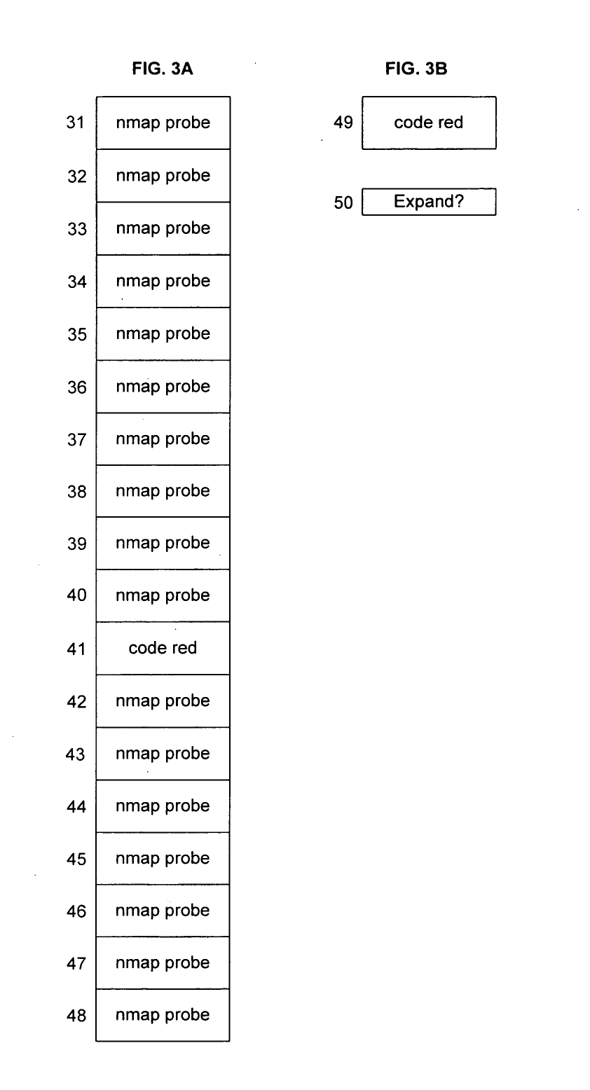

When the alert log 16 is displayed, high importance alerts such as, for example, a code red match, may be overcrowded by an abundance of alerts of low importance, such as, for example, multiple Nmap probe matches. FIG. 3A shows an example of the displaying of an alert log that has been over crowded. Alerts 31-40 and 41-48 depict Nmap probe matches of low importance. Alert 41 depicts a code red match of high importance. It can often be difficult to identify the alert that represents a threat of high importance to a computer system and network security because of the overcrowded state of the alert log 16.

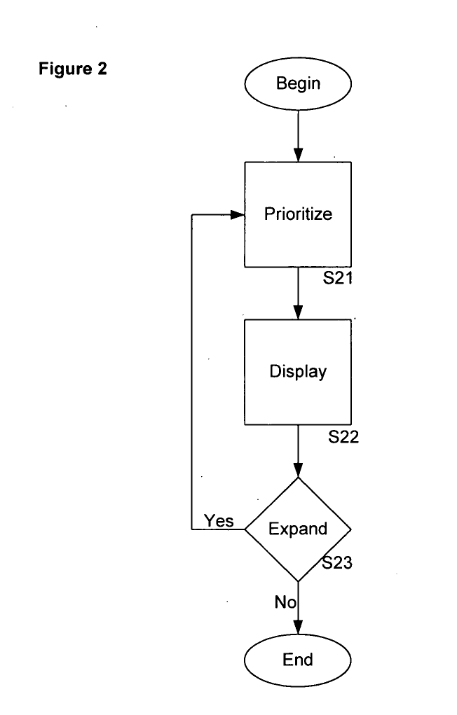

FIG. 2 shows a procedure for displaying an alert log 16 according to embodiments of the present disclosure. Alerts within the alert log 16 can be prioritized (Step S21) according to, for example, such values as the potential damage that can be caused by the malicious program detected, the probability that the damage will occur, the confidence information signifying how confident the scanner was in making its determination that a malicious program has been detected, statistical information, risk assessment values associated with signatures and/or supplied by the developer of the signatures, etc. Statistical information includes, for example, statistics concerning the frequency of a particular matching wherein commonly matched malicious programs, for example Nmap probes, may be perceived as less of a threat.

After relevant information has been considered, a category can be assigned to each alert within the alert log 16. Alert categories may be, for example, high importance and low importance. For example, Nmap probe matches would be categorized as low importance and code red matches categorized as high importance.

FIG. 3B shows an example of an alert display according to an embodiment of the present disclosure. Prioritized alerts can then be displayed (Step S22) according to the determined importance in such a way that greater attention is given to alerts of higher priority. For example, only high importance alerts may be initially displayed along with an option to expand the display to show low importance alerts. In the example shown in FIG. 3B, only the high importance code red alert is displayed. Where the network administrator chooses to expand the display, the alerts may be re-prioritized (Step S21) so that all alerts can be displayed (Step S22). For example, in the display shown in FIG. 3B, the network administrator is given the option of clicking on the Expand button 50 in order to provide the more comprehensive display as shown in FIG. 3A.

Other methods for potentially displaying alerts can be provided according to the present disclosure. For example, the complete list of alerts may be displayed in priority order. For example, high importance alerts may be displayed with particular prominence, for example, highlighted, bolded, underlined, set aside, etc.

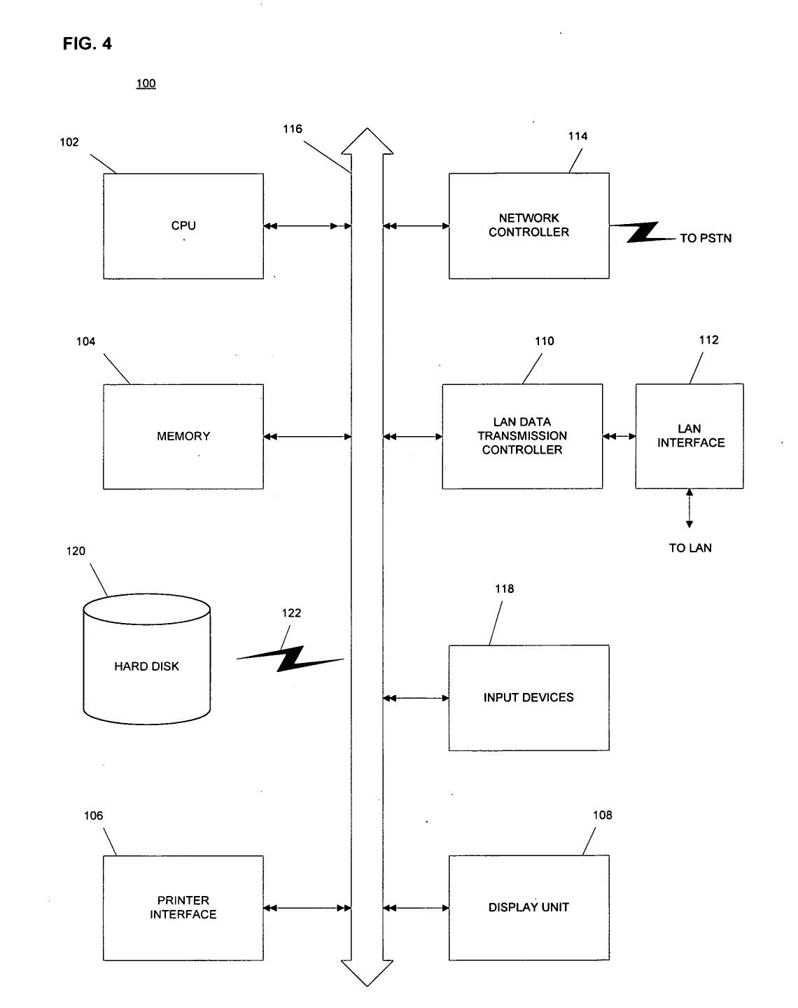

FIG. 4 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 100 may include, for example, a central processing unit (CPU) 102, random access memory (RAM) 104, a printer interface 106, a display unit 108, a local area network (LAN) data transmission controller 110, a LAN interface 112, a network controller 114, an internal buss 116, and one or more input devices 118, for example, a keyboard, mouse etc. As shown, the system 100 may be connected to a data storage device, for example, a hard disk, 120 via a link 122.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A method for detecting malicious programs, the method comprising:
scanning data to be scanned to detect a malicious program infection;
generating an alert when a malicious program infection has been detected; and
adding said alert to an alert log along with information pertaining to an importance of said detected malicious program infection.

2. The method according to claim 1, wherein said importance is based on a risk assessment value.

3. The method according to claim 2, wherein said risk assessment value is provided along with signatures used in said scanning data to be scanned to detect said malicious program infection.

4. The method according to claim 3, wherein said risk assessment value provided along with said signatures may be subsequently modified by a network administrator.

5. The method according to claim 2, wherein said risk assessment value is determined by a network administrator.

6. The method according to claim 1, wherein said importance is based on a confidence level.

7. The method according to claim 1, wherein said importance is based on a key attribute pertaining to said detection of said malicious program.

8. A method for displaying an alert log comprising one or more alerts, the method comprising:
prioritizing said one or more alerts according to an importance of each of said one or more alerts; and
displaying said one or more alerts according to said priority.

9. The method according to claim 8, wherein said importance is based on a risk assessment value.

10. The method according to claim 9, wherein said risk assessment value is provided along with signatures used in said scanning data to be scanned to detect said malicious program infection.

11. The method according to claim 10, wherein said risk assessment value provided along with said signatures may be subsequently modified by a network administrator.

12. The method according to claim 9, wherein said risk assessment value is determined by a network administrator.

13. The method according to claim 8, wherein said importance is based on a confidence level.

14. The method according to claim 8, wherein said importance is based on a key attribute pertaining to said detection of said malicious program.

15. The method of claim 8, wherein prioritizing said one or more alerts according to an importance of each of said one or more alerts further comprises categorizing said one or more alerts as high importance and low importance based on said importance of each of said one or more alerts.

16. The method according to claim 15, wherein displaying said one or more alerts according to said priority further comprises displaying only those of said one or more alerts that have been categorized as high importance and providing an option for the display of those of said one or more alerts that have been categorized as low importance.

17. A system for detecting malicious programs, the system comprising:
a scanning unit for scanning data to be scanned to detect a malicious program infection;
a generating unit for generating an alert when a malicious program infection has been detected; and
an adding unit for adding said alert to an alert log along with information pertaining to an importance of said detected malicious program infection.

18. The system according to claim 17, wherein said importance is based on a risk assessment value.

19. The system according to claim 18, wherein said risk assessment value is provided along with signatures used in said scanning data to be scanned to detect said malicious program infection.

20. The system according to claim 19, wherein said risk assessment value provided along with said signatures may be subsequently modified by a network administrator.

21. The system according to claim 18, wherein said risk assessment value is determined by a network administrator.

22. The system according to claim 17, wherein said importance is based on a confidence level.

23. The system according to claim 17, wherein said importance is based on a key attribute pertaining to said detection of said malicious program.

24. A system for displaying an alert log comprising one or more alerts, the system comprising:
a prioritizing unit for prioritizing said one or more alerts according to an importance of each of said one or more alerts; and
a displaying unit for displaying said one or more alerts according to said priority.

25. The system according to claim 24, wherein said importance is based on a risk assessment value.

26. The system according to claim 25, wherein said risk assessment value is provided along with signatures used in said scanning data to be scanned to detect said malicious program infection.

27. The system according to claim 26, wherein said risk assessment value provided along with said signatures may be subsequently modified by a network administrator.

28. The system according to claim 25, wherein said risk assessment value is determined by a network administrator.

29. The system according to claim 24, wherein said importance is based on a confidence level.

30. The system according to claim 24, wherein said importance is based on a key attribute pertaining to said detection of said malicious program.

31. The system of claim 24, wherein prioritizing said one or more alerts according to an importance of each of said one or more alerts further comprises categorizing said one or more alerts as high importance and low importance based on said importance of each of said one or more alerts.

32. The system according to claim 31, wherein displaying said one or more alerts according to said priority further comprises displaying only those of said one or more alerts that have been categorized as high importance and providing an option for the display of those of said one or more alerts that have been categorized as low importance.

33. A computer system comprising:
a processor; and
a program storage device readable by the computer system, embodying a program of instructions executable by the processor to perform method steps for detecting malicious programs, the method comprising:
scanning data to be scanned to detect a malicious program infection;
generating an alert when a malicious program infection has been detected; and
adding said alert to an alert log along with information pertaining to an importance of said detected malicious program infection.

34. The computer system according to claim 33, wherein said importance is based on a risk assessment value.

35. The computer system according to claim 34, wherein said risk assessment value is provided along with signatures used in said scanning data to be scanned to detect said malicious program infection.

36. The computer system according to claim 35, wherein said risk assessment value provided along with said signatures may be subsequently modified by a network administrator.

37. The computer system according to claim 34, wherein said risk assessment value is determined by a network administrator.

38. The computer system according to claim 33, wherein said importance is based on a confidence level.

39. The computer system according to claim 33, wherein said importance is based on a key attribute pertaining to said detection of said malicious program.

40. A computer system comprising:
a processor; and
a program storage device readable by the computer system, embodying a program of instructions executable by the processor to perform method steps for displaying an alert log comprising one or more alerts, the method comprising:
prioritizing said one or more alerts according to an importance of each of said one or more alerts; and
displaying said one or more alerts according to said priority.

41. The computer system according to claim 40, wherein said importance is based on a risk assessment value.

42. The computer system according to claim 41, wherein said risk assessment value is provided along with signatures used in said scanning data to be scanned to detect said malicious program infection.

43. The computer system according to claim 42, wherein said risk assessment value provided along with said signatures may be subsequently modified by a network administrator.

44. The computer system according to claim 41, wherein said risk assessment value is determined by a network administrator.

45. The computer system according to claim 40, wherein said importance is based on a confidence level.

46. The computer system according to claim 40, wherein said importance is based on a key attribute pertaining to said detection of said malicious program.

47. The computer system of claim 40, wherein prioritizing said one or more alerts according to an importance of each of said one or more alerts further comprises categorizing said one or more alerts as high importance and low importance based on said importance of each of said one or more alerts.

48. The computer system according to claim 47, wherein displaying said one or more alerts according to said priority further comprises displaying only those of said one or more alerts that have been categorized as high importance and providing an option for the display of those of said one or more alerts that have been categorized as low importance.
